(19) United States
(12) Patent Application Publication
(10) Pub. No.: US 2026/0201817 A1
(43) Pub. Date: Jul. 16, 2026

(54) CASING AND LINER ASSEMBLY OF GAS TURBINE ENGINE

(71) Applicant: Pratt & Whitney Canada Corp., Longueuil, Québec (CA)

(72) Inventor: Franco Di Paola, Montreal Nord, Québec (CA)

(21) Appl. No.: 19/016,415

(22) Filed: Jan. 10, 2025

(51) Int. Cl. F01D 25/24

(52) U.S. Cl. CPC F01D 25/24; F05D 2220/323; F05D 2240/14; F05D 2260/30

(57) ABSTRACT

A case assembly of a gas turbine engine includes an outer case having at least one outer case tab extending from a first end of the outer case, and a liner positioned radially inboard of the outer case and having at least one liner tab extending from a first end of the liner. The at least one outer case tab is interactive with the at least one liner tab to align the liner to the outer case. At least one fastener is installed to one of the at least one outer case tab or the at least one liner tab. The at least one fastener bypasses the other of the at least one outer case tab or the at least one liner tab.

### BACKGROUND

Exemplary embodiments pertain to the art of gas turbine engines and in particular to assembly of a liner to a case of a gas turbine engine.

Gas turbine engines use one or more case assemblies to enclose and support rotating components of the gas turbine engines. Current configurations of, for example, a turbine support case assembly has a containment ring with an integrated lead in chamfer to facilitate subsequent piston ring installation followed by an area where rivets are installed. This design requires more axial space as the 2 above functions, piston ring installation and rive installation, are done axially independently of each other. This requires a relatively large and more expensive piece of raw material, and also requires drilling of rivet holes at assembly to ensure proper alignment, which is undesirable. Subsequent realignment after disassembly is difficult as the tight interference fit does not allow much time to relocate and align the rivet holes to reinstall rivets.

### BRIEF DESCRIPTION

In one exemplary embodiment, a case assembly of a gas turbine engine includes an outer case having at least one outer case tab extending from a first end of the outer case, and a liner positioned radially inboard of the outer case and having at least one liner tab extending from a first end of the liner. The at least one outer case tab is interactive with the at least one liner tab to align the liner to the outer case. At least one fastener is installed to one of the at least one outer case tab or the at least one liner tab. The at least one fastener bypasses the other of the at least one outer case tab or the at least one liner tab.

Additionally or alternatively, in this or other embodiments a retaining bracket extends through an opening defined by the at least one outer case tab and the at least one liner. The retaining bracket axially retains the liner relative to the outer case.

Additionally or alternatively, in this or other embodiments the at least one fastener extends through the at least one outer case tab and into the retaining bracket.

Additionally or alternatively, in this or other embodiments the at least one outer case tab is two outer case tabs, and the at least one liner tab is one liner tab. The liner tab is positioned between the two outer case tabs to rotationally align the liner to the outer case.

Additionally or alternatively, in this or other embodiments the at least one outer case tab and the at least one liner tab are C-shaped.

Additionally or alternatively, in this or other embodiments an opening of the C-shaped outer case tab faces radially inwardly, and an opening of the C-shaped liner tab faces radially outwardly.

Additionally or alternatively, in this or other embodiments the at least one outer case tab is two outer case tabs, and the at least one liner tab is one liner tab. The liner tab extends between the two outer case tabs. A bushing is installed into the liner tab between the two outer case tabs to rotationally align the liner to the outer case.

Additionally or alternatively, in this or other embodiments a retaining bracket is secured to the two outer case tabs to retain the bushing to the liner tab.

Additionally or alternatively, in this or other embodiments the at least one fastener is installed into the bushing.

Additionally or alternatively, in this or other embodiments the at least one fastener is at least one rivet.

In another exemplary embodiment, a gas turbine engine includes a combustor, and a turbine driven by products of the combustor. A case assembly at least partially encloses the turbine. The case assembly includes an outer case having at least one outer case tab extending from a first end of the outer case, and a liner positioned radially inboard of the outer case and having at least one liner tab extending from a first end of the liner. The at least one outer case tab is interactive with the at least one liner tab to align the liner to the outer case. At least one fastener is installed to one of the at least one outer case tab or the at least one liner tab. The at least one fastener bypasses the other of the at least one outer case tab or the at least one liner tab.

Additionally or alternatively, in this or other embodiments a retaining bracket extends through an opening defined by the at least one outer case tab and the at least one liner. The retaining bracket axially retains the liner relative to the outer case.

Additionally or alternatively, in this or other embodiments the at least one fastener extends through the at least one outer case tab and into the retaining bracket.

Additionally or alternatively, in this or other embodiments the at least one outer case tab is two outer case tabs, and the at least one liner tab is one liner tab. The liner tab is positioned between the two outer case tabs to rotationally align the liner to the outer case.

Additionally or alternatively, in this or other embodiments the at least one outer case tab and the at least one liner tab are C-shaped.

Additionally or alternatively, in this or other embodiments an opening of the C-shaped outer case tab faces radially inwardly, and an opening of the C-shaped liner tab faces radially outwardly.

Additionally or alternatively, in this or other embodiments the at least one outer case tab is two outer case tabs, and the at least one liner tab is one liner tab. The liner tab extends between the two outer case tabs. A bushing is installed into the liner tab between the two outer case tabs to rotationally align the liner to the outer case.

Additionally or alternatively, in this or other embodiments a retaining bracket is secured to the two outer case tabs to retain the bushing to the liner tab.

Additionally or alternatively, in this or other embodiments the at least one fastener is installed into the bushing.

Additionally or alternatively, in this or other embodiments the at least one fastener is at least one rivet.

### BRIEF DESCRIPTION OF THE DRAWINGS

The following descriptions should not be considered limiting in any way. With reference to the accompanying drawings, like elements are numbered alike:

FIG. 1 is a cross-sectional view of an embodiment of a gas turbine engine;

FIG. 2 is a perspective view of an exemplary embodiment of a case and liner assembly;

FIG. 3 is a partial perspective view of the embodiment of FIG. 2;

FIG. 4 is a partial cross-sectional view of the embodiment of FIG. 2;

FIG. 5 is a partially disassembled view of the embodiment of FIG. 2;

FIG. 6 is a partial illustration of an embodiment of assembly of a liner to an outer case;

FIG. 7 is another partial illustration of assembly of a liner to an outer case;

FIG. 8 is a perspective view of another exemplary embodiment of a case and liner assembly;

FIG. 9 is a partial cross-sectional view of the embodiment of FIG. 8;

FIG. 10 is a perspective view of yet another exemplary embodiment of a case and liner assembly; and

FIG. 11 is a partial cross-sectional view of the embodiment of FIG. 10.

### DETAILED DESCRIPTION

A detailed description of one or more embodiments of the disclosed apparatus and method are presented herein by way of exemplification and not limitation with reference to the Figures.

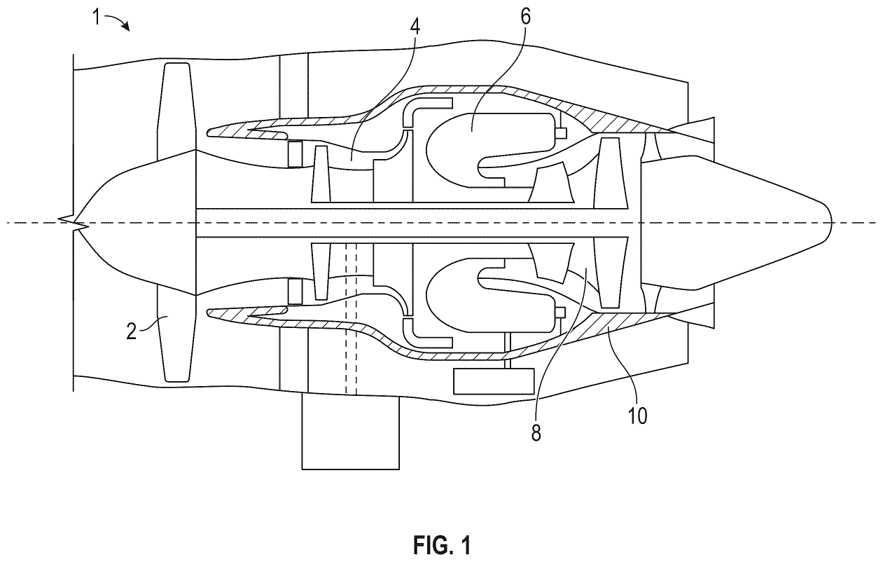

FIG. 1 illustrates a gas turbine engine 1 of a type preferably provided for use in subsonic flight, generally comprising in serial flow communication a fan 2 through which ambient air is propelled, a compressor section 4 for pressurizing the air, a combustor 6 in which the compressed air is mixed with fuel and ignited for generating an annular stream of hot combustion gases, and a turbine section 8 for extracting energy from the combustion gases.

Aircraft engines, including the type of engine shown in FIG. 1, typically have one or more cases 10 to enclose and support components of the gas turbine engine 1. Such cases may include a turbine case 10 surrounding and supporting the turbine section 8.

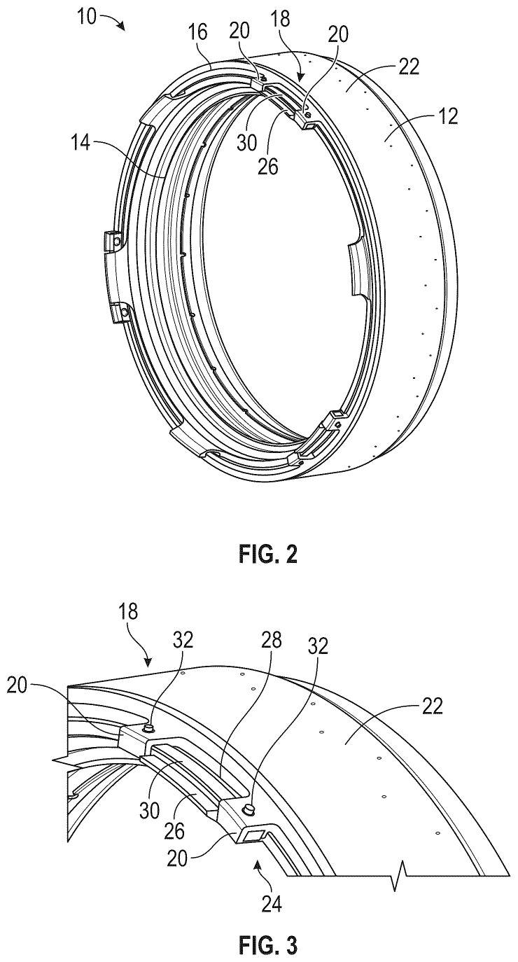

Illustrated in FIG. 2 is an exemplary embodiment of a turbine case 10. The turbine case 10 includes an outer case 12 and a liner 14 located radially inboard of the outer case 12 and secured to the outer case 12. The liner 14 is secured to the outer case 12 at at least a first case end 16 of the outer case 12 via one or more liner attachments 18. An exemplary liner attachment 18 is illustrated in FIG. 3. In this embodiment, two outer case tabs 20 extend from a case body 22 of the outer case 12. The case tabs 20 extend from the first case end 16, which in this embodiment is an axially forward end of the turbine case 10. The case tabs 20 are C-shaped, with a case tab opening 24 defined by the C-shape facing radially inwardly. The liner 14 includes a liner tab 26 disposed circumferentially between the case tabs 20. In embodiments, the liner tab 26 may be similarly C-shaped, with a liner tab opening 28 defined by the C-shape facing radially outwardly.

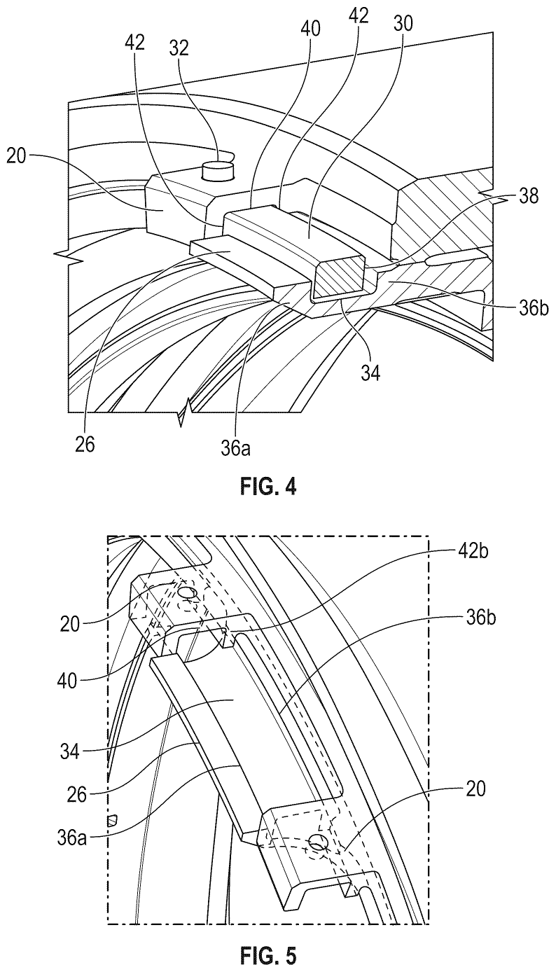

A retention plate 30 is installed such that the retention plate 30 extends through both of the case tab openings 24 and the liner tab opening 28 and is held in place by fasteners, such as retention rivets 32 extending through each of the case tab openings 24 and into the retention plate 30. Referring now to FIG. 4, with continued reference to FIG. 3, the liner tab opening 28 includes an opening base 34 and two axially spaced apart opening walls 36, with the opening walls 36 extending radially outwardly from the opening base 34. The retention plate 30 in some embodiments has a rectangular cross-sectional shape, and is positioned in the liner tab opening 28 so that the opening walls 36 of the liner tab opening 28 at least partially overlap plate sidewalls 38 of the retention plate 30. Thus the retention plate 30 retains the liner 14 relative to the outer case 12 via an interference with at least a forward opening wall 36a of the liner tab opening 28. Additionally, the case tab openings 24 each include a case tab base 40 and two axially spaced-apart case tab sidewalls 42 extending radially inwardly from the case tab base 40. The case tab sidewalls 42 each at least partially radially overlap the opening walls 36. In this way, the liner tab 26 is rotationally retained between the case tabs 20 via a rotational interference between the case tab sidewalls 42 and the opening walls 26 thus rotationally retaining the liner 14 relative to the outer case 12.

Referring now to FIG. 5, in some embodiments an aft opening wall 36b of the liner 14 at least partially radially overlaps corresponding aft case tab sidewalls 42b, with the aft case tab sidewalls 42b located axially forward of the aft opening wall 36b. This overlap, together with the interference between the retention plate 30 and the forward opening wall 36a of the liner tab opening 28 axially retains the liner 14 relative to the outer case 12. While in the embodiment described herein, a single liner tab 26 is positioned between two case tabs 20, in other embodiments the configuration may be substantially reversed, so that a single case tab is positioned between two liner tabs.

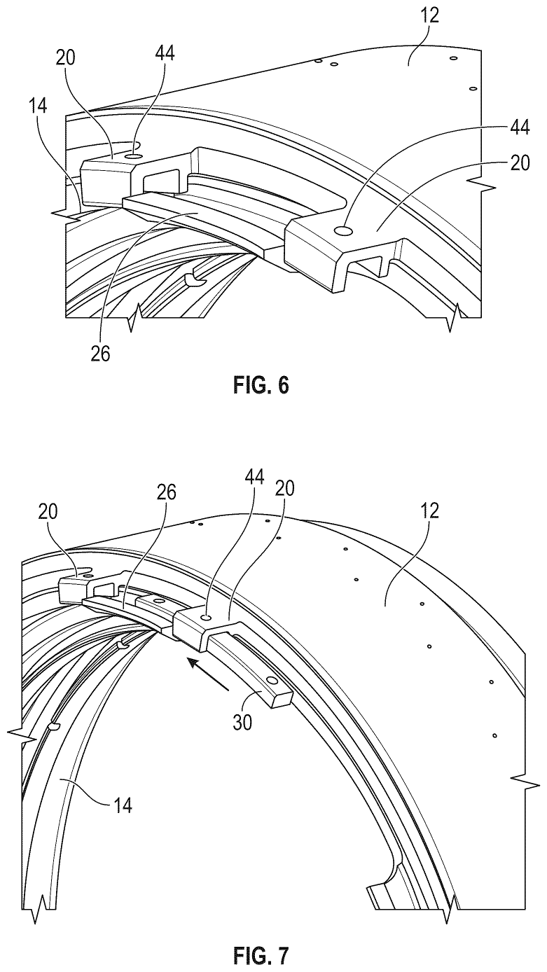

Referring now to FIG. 6, to assemble the liner 14 to the outer case 12, the liner 14 is placed so that the liner tab 26 is aligned between the two case tabs 20 to rotationally and at least partially axially align the components. As illustrated in FIG. 7, once the components are aligned, the retention plate 30 is installed from one circumferential end, through a first case tab 20, through the liner tab 26 and then through a second case tab 20. Once the retention plate 30 is installed, the retention rivets 30 (shown in FIG. 3) are installed through rivet openings 44 in the case tabs 20 and into the retention plate 30.

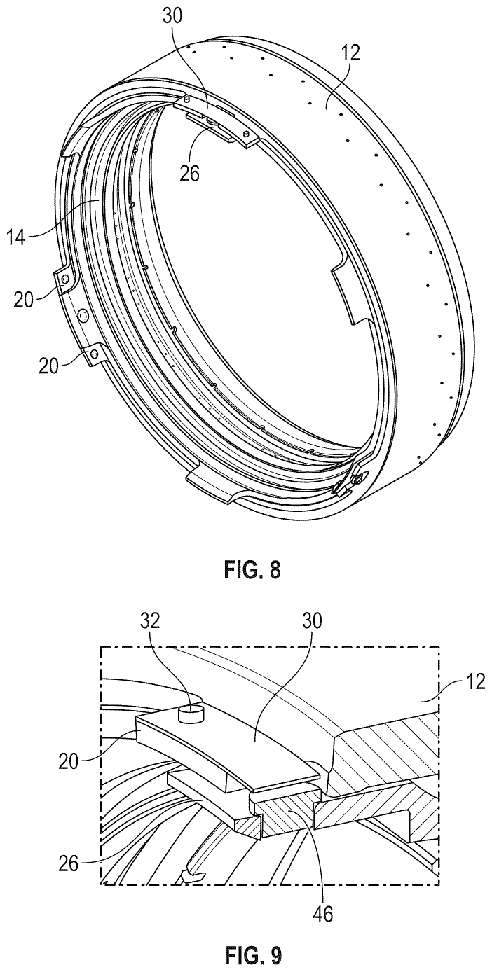

Another embodiment is illustrated in FIG. 8, in this embodiment, the case tabs 20 and the liner tab 26 may be substantially flat, and as illustrated further in FIG. 9 the case tabs 20 rest on the liner tab 26. A bushing or pin 46 is installed into the liner tab 26 between the case tabs 20 and extends radially above the liner tab 26 to rotationally align and retain the liner 14 relative to the outer case 10. The pin 46 further provides axial retention via potential axial interference with the outer case 10. The retention plate 30 is installed to the case tabs 20 by, for example, retention rivets 32, and acts to radially retain the pin 46 in the liner tab 26.

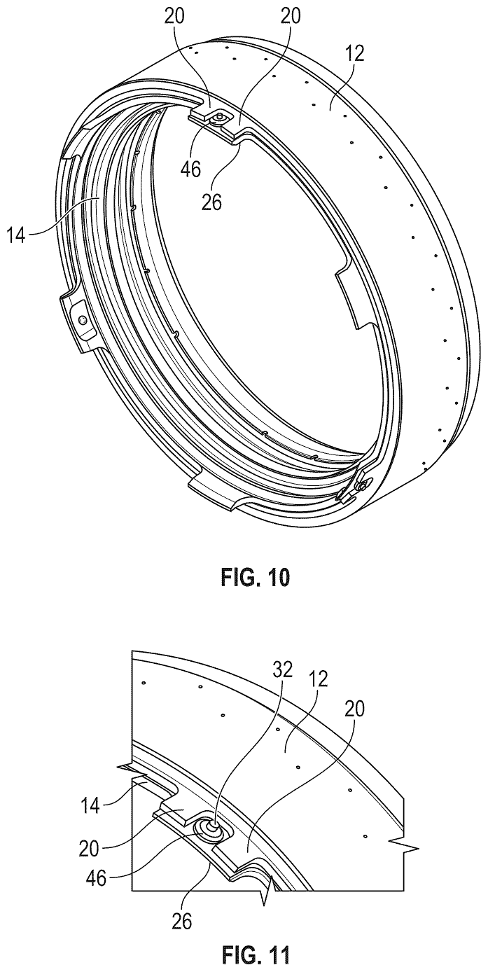

In another embodiment illustrated in FIGS. 10 and 11, the retention plate 30 is eliminated, and the pin 46 is retained in place in the liner tab 26 by a retention rivet 32 installed into the pin 46.

The structures described herein improve alignment and retention of the liner 14 in the outer case 10, with the liner 14 essentially self-aligning with the outer case 10 upon assembly via features of the case tabs 20 and the liner tab 26. The rivets utilized are only to hold the retention features such as the retention plate 30 and/or pin 46 in place and thus do not need to carry retention loads of the liner to the case.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A case assembly of a gas turbine engine, comprising:
an outer case having at least one outer case tab extending from a first end of the outer case;
a liner disposed radially inboard of the outer case and having at least one liner tab extending from a first end of the liner, the at least one outer case tab interactive with the at least one liner tab to align the liner to the outer case; and
at least one fastener installed to one of the at least one outer case tab or the at least one liner tab, the at least one fastener bypassing the other of the at least one outer case tab or the at least one liner tab.

2. The case assembly of claim 1, further comprising a retaining bracket extending through an opening defined by the at least one outer case tab and the at least one liner, the retaining bracket axially retaining the liner relative to the outer case.

3. The case assembly of claim 2, wherein the at least one fastener extends through the at least one outer case tab and into the retaining bracket.

4. The case assembly of claim 2, wherein the at least one outer case tab is two outer case tabs, and the at least one liner tab is one liner tab, the liner tab disposed between the two outer case tabs to rotationally align the liner to the outer case.

5. The case assembly of claim 2, wherein the at least one outer case tab and the at least one liner tab are C-shaped.

6. The case assembly of claim 5, wherein an opening of the C-shaped outer case tab faces radially inwardly, and an opening of the C-shaped liner tab faces radially outwardly.

7. The case assembly of claim 1, wherein:
the at least one outer case tab is two outer case tabs, and the at least one liner tab is one liner tab, the liner tab extending between the two outer case tabs; and
a bushing is installed into the liner tab between the two outer case tabs to rotationally align the liner to the outer case.

8. The case assembly of claim 7, further comprising a retaining bracket secured to the two outer case tabs to retain the bushing to the liner tab.

9. The case assembly of claim 7, wherein the at least one fastener is installed into the bushing.

10. The case assembly of claim 1, wherein the at least one fastener is at least one rivet.

11. A gas turbine engine, comprising:
a combustor;
a turbine driven by products of the combustor; and
a case assembly at least partially enclosing the turbine, the case assembly including:
an outer case having at least one outer case tab extending from a first end of the outer case;
a liner disposed radially inboard of the outer case and having at least one liner tab extending from a first end of the liner, the at least one outer case tab interactive with the at least one liner tab to align the liner to the outer case; and
at least one fastener installed to one of the at least one outer case tab or the at least one liner tab, the at least one fastener bypassing the other of the at least one outer case tab or the at least one liner tab.

12. The gas turbine engine of claim 11, further comprising a retaining bracket extending through an opening defined by the at least one outer case tab and the at least one liner, the retaining bracket axially retaining the liner relative to the outer case.

13. The gas turbine engine of claim 12, wherein the at least one fastener extends through the at least one outer case tab and into the retaining bracket.

14. The gas turbine engine of claim 12, wherein the at least one outer case tab is two outer case tabs, and the at least one liner tab is one liner tab, the liner tab disposed between the two outer case tabs to rotationally align the liner to the outer case.

15. The gas turbine engine of claim 12, wherein the at least one outer case tab and the at least one liner tab are C-shaped.

16. The gas turbine engine of claim 15, wherein an opening of the C-shaped outer case tab faces radially inwardly, and an opening of the C-shaped liner tab faces radially outwardly.

17. The gas turbine engine of claim 11, wherein:
the at least one outer case tab is two outer case tabs, and the at least one liner tab is one liner tab, the liner tab extending between the two outer case tabs; and
a bushing is installed into the liner tab between the two outer case tabs to rotationally align the liner to the outer case.

18. The gas turbine engine of claim 17, further comprising a retaining bracket secured to the two outer case tabs to retain the bushing to the liner tab.

19. The gas turbine engine of claim 17, wherein the at least one fastener is installed into the bushing.

20. The gas turbine engine of claim 11, wherein the at least one fastener is at least one rivet.
